(19) United States
(12) Patent Application Publication
(10) Pub. No.: US 2011/0134254 A1
(43) Pub. Date: Jun. 9, 2011

(54) MEASURING AND CORRECTING LENS DISTORTION IN A MULTISPOT SCANNING DEVICE

(75) Inventors: Bas Hulsken, Eindhoven (NL); Sjoerd Stallinga, Eindhoven (NL)

(73) Assignee: KONINKLIJKE PHILIPS ELECTRONICS N.V., EINDHOVEN (NL)

(21) Appl. No.: 13/058,066

(22) PCT Filed: Aug. 7, 2009
(86) PCT No.: PCT/IB2009/053489

§ 371 Date: Feb. 8, 2011

(30) Foreign Application Priority Data
Aug. 13, 2008 (EP) 08305469.2

(51) Int. Cl. H04N 17/00

(52) U.S. Cl. 348/187; 348/E17.002

(57) ABSTRACT

The invention provides a method of determining the distortion of an imaging system (32), the imaging system having an object plane (40) and an image plane (42). The method comprises the steps of determining (204) the positions of the image light spots (46) on a sensitive area (44) of an image sensor (34) by analyzing the image data; and fitting (205) a mapping function such that the mapping function maps the lattice points of an auxiliary lattice (48) into the positions of the image light spots (46), wherein the auxiliary lattice (48) is geometrically similar to the Bravais lattice (8) of the probe light spots (6). The invention also provides a method of imaging a sample, using an imaging system (32) having an object plane (40) and an image plane (42), the method comprising the steps of determining (304) readout points on the sensitive area (44) of an image sensor (34) by applying a mapping function to the lattice points of an auxiliary lattice (48), the auxiliary lattice being geometrically similar to a Bravais lattice (8) of probe light spots (6); and reading (305) image data from the readout points on the sensitive area (44). Also disclosed are a measuring system (10) for determining the distortion of an imaging system, and a multispot optical scanning device (10).

### FIELD OF THE INVENTION

The invention relates to a method of determining the distortion of an imaging system, the imaging system having an object plane and an image plane.

The invention also relates to a measuring system for determining the distortion of an imaging system having an object plane and an image plane, the measuring system comprising a spot generator for generating an array of probe light spots in the object plane, the probe light spots being arranged according to a one-dimensional or two-dimensional Bravais lattice, an image sensor having a sensitive area arranged so as to be able to interact with the array of image light spots, and an information processing device coupled to the image sensor.

The invention further relates to a method of imaging a sample, using an imaging system having an object plane and an image plane.

The invention further relates to a multispot optical scanning device, in particular a multispot optical scanning microscope, comprising an imaging system having an object plane and an image plane, a spot generator for generating an array of probe light spots in the object plane, thereby generating a corresponding array of image light spots in the image plane, wherein the probe light spots are arranged according to a one-dimensional or two-dimensional Bravais lattice, an image sensor having a sensitive area arranged so as to be able to interact with the array of image light spots, and an information processing device coupled to the image sensor.

### BACKGROUND OF THE INVENTION

Optical scanning microscopy is a well-established technique for providing high resolution images of microscopic samples. According to this technique, one or several distinct, high-intensity light spots are generated in the sample. Since the sample modulates the light of the light spot, detecting and analyzing the light coming from the light spot yields information about the sample at that light spot. A full two-dimensional or three-dimensional image of the sample is obtained by scanning the relative position of the sample with respect to the light spots. The technique finds applications in the fields of life sciences (inspection and investigation of biological specimens), digital pathology (pathology using digitized images of microscopy slides), automated image based diagnostics (e.g. for cervical cancer, malaria, tuberculosis), microbiology screening like Rapid Microbiology (RMB), and industrial metrology.

A light-spot generated in the sample may be imaged from any direction, by collecting light that leaves the light spot in that direction. In particular, the light spot may be imaged in transmission, that is, by detecting light on the far side of the sample. Alternatively, a light spot may be imaged in reflection, that is, by detecting light on the near side of the sample. In the technique of confocal scanning microscopy, the light spot is customarily imaged in reflection via the optics generating the light spot, i.e. via the spot generator.

U.S. Pat. No. 6,248,988 B1 proposes a multispot scanning optical microscope featuring an array of multiple separate focused light spots illuminating the object and a corresponding array detector detecting light from the object for each separate spot. Scanning the relative positions of the array and object at slight angles to the rows of the spots then allows an entire field of the object to be successively illuminated and imaged in a swath of pixels. Thereby the scanning speed is considerably augmented.

The array of light spots required for this purpose is usually generated from a collimated beam of light that is suitably modulated by a spot generator so as to form the light spots at a certain distance from the spot generator. According to the state of the art, the spot generator is either of the refractive or of the diffractive type. Refractive spot generators include lens systems such as microlens arrays, and phase structures such as the binary phase structure proposed in WO2006/035393.

Regarding the Figures in the present application, any reference numeral appearing in different Figures indicates similar or analogous components.

FIG. 1 schematically illustrates an example of a multispot optical scanning microscope. The microscope 10 comprises a laser 12, a collimator lens 14, a beam splitter 16, a forward-sense photodetector 18, a spot generator 20, a sample assembly 22, a scan stage 30, imaging optics 32, an image sensor in the form of a pixelated photodetector 34, a video processing integrated circuit (IC) 36, and a personal computer (PC) 38. The sample assembly 22 can be composed of a cover slip 24, a sample 26, and a microscope slide 28. The sample assembly 22 is placed on the scan stage 30 coupled to an electric motor (not shown). The imaging optics 32 is composed of a first objective lens 32a and a second lens 32b for making the optical image. The objective lenses 32a and 32b may be composite objective lenses. The laser 12 emits a light beam that is collimated by the collimator lens 14 and incident on the beam splitter 16. The transmitted part of the light beam is captured by the forward-sense photodetector 18 for measuring the light output of the laser 12. The results of this measurement are used by a laser driver (not shown) to control the laser's light output. The reflected part of the light beam is incident on the spot generator 20. The spot generator 20 modulates the incident light beam to produce an array of probe light spots 6 (shown in FIG. 2) in the sample 26. The imaging optics 32 has an object plane 40 coinciding with the position of the sample 26 and an image plane 42 coinciding with a sensitive surface 44 of the pixelated photodetector 32. The imaging optics 32 generates in the image plane 44 an optical image of the sample 26 illuminated by the array of scanning spots. Thus an array of image light spots is generated on the sensitive area 44 of the pixelated photodetector 34. The data read out from the photodetector 34 is processed by the video processing IC 36 to a digital image that is displayed and possibly further processed by the PC 38.

In FIG. 2 there is schematically represented an array 6 of light spots generated in the sample 26 shown in FIG. 3. The array 6 is arranged along a rectangular lattice having square elementary cells of pitch p. The two principal axes of the grid are taken to be the x and the y direction, respectively. The array is scanned across the sample in a direction which makes a skew angle γ with either the x or the y direction. The array comprises Lₓ×L_{y} spots labelled (i, j), where i and j run from 1 to Lₓ and L_{y}, respectively. Each spot scans a line 81, 82, 83, 84, 85, 86 in the x-direction, the y-spacing between neighbouring lines being R/2 where R is the resolution and R/2 the sampling distance. The resolution is related to the angle γ by p sin γ=R/2 and p cos γ=Lₓ R/2. The width of the scanned “stripe” is w=LR/2. The sample is scanned with a speed v, making the throughput (in scanned area per time) wv=LRv/2. Clearly, a high scanning speed is advantageous for throughput. However, the resolution along the scanning direction is given by v/f, where f is the frame rate of the image sensor.

Reading out intensity data from every elementary area of the image sensor while scanning the sample could render the scanning process very slow. Therefore, image data is usually read out only from those elementary areas that match predicted positions of the image light spots. Customarily the positions of the image light spots are determined in a preparative step prior to scanning the sample, by fitting a lattice to the recorded images. Fitting a lattice has certain advantages as compared to determining the positions of the spots without taking into account the correlations between the spots. Firstly, it is more robust to measurement errors. Secondly, it avoids the need of memorizing the individual position of the spots. Thirdly, computing the spot positions from the lattice parameters can be much more rapid than reading them from a memory.

A problem is that in general the optical imaging system, such as the lens system 32 discussed above with reference to FIG. 1, suffers from distortion. This distortion can either be of the barrel or pincushion type, leading to an outward or inward bulging appearance of the resulting images. This distortion generally appears to some degree in all cameras, microscopes and telescopes containing optical lenses or curved mirrors. The distortion deforms a rectangular lattice into a curved lattice. As a consequence the step of fitting a Bravais lattice to the recorded image spots does not function properly. At some lattice points the actual spot is significantly displaced. As a result the intensity in the neighbourhood of the lattice points does not correspond to the intensity in the neighbourhood of the spots, and artefacts in the digital image will occur. As compared to a conventional optical microscope, the effects of distortion by the optical imaging system are more noticeable in images generated by a multispot scanning optical system. In the case of a conventional optical system, such as a conventional optical microscope or camera, the effects of distortion are mostly restricted to the corners of the image. In contrast, in the case of a multispot scanning optical system, the effects of distortion are distributed over the entire digital image. This is due to the fact that neighbouring scan lines can originate from spots quite distributed over the field of view of the optical system, as can be deduced from FIG. 2 described above.

It is an object of the invention to provide a method and a device for measuring the distortion of an imaging system. It is another object of the invention to provide a method and an optical scanning device for generating digital images of an improved quality.

These objects are achieved by the features of the independent claims. Further specifications and preferred embodiments are outlined in the dependent claims.

### SUMMARY OF THE INVENTION

According to a first aspect of the invention, the method for determining the distortion of an imaging system comprises the steps of
generating an array of probe light spots in the object plane, thereby generating a corresponding array of image light spots in the image plane, wherein the probe light spots are arranged according to a one-dimensional or two-dimensional Bravais lattice;
placing an image sensor such that a sensitive area thereof interacts with the image light spots;
reading image data from the image sensor;
determining the positions of the image light spots on the image sensor by analyzing the image data;
fitting a mapping function such that the mapping function maps the lattice points of an auxiliary lattice into the positions of the image light spots, wherein the auxiliary lattice is geometrically similar to the Bravais lattice of the probe light spots.

Herein it is understood that the mapping function maps any point of a plane into a another point of the plane. The mapping function is thus indicative of the distortion of the imaging system. It is further assumed that the mapping function is a known function which depends on one or several parameters. Fitting the mapping function thus involves adjusting the values of these parameters. The one or several parameters may be adjusted, for example, so as to minimize a mean deviation between the mapped auxiliary lattice points and the positions of the image light spots. In the case where the Bravais lattice is two-dimensional, it may be of any of the five existing types of Bravais lattices: oblique, rectangular, centred rectangular, hexagonal, and square. The auxiliary lattice being geometrically similar to the Bravais lattice of the probe light spots, the auxiliary lattice is a Bravais lattice of the same type as the lattice of the probe light spots. Thus the two lattices differ at most in their size and in their orientation within the image plane. Arranging the probe light spots according to a Bravais lattice is particularly advantageous, since this allows for a fast identification of parameters other than the distortion itself, notably the orientation of the distorted lattice of image light spots relative to the auxiliary lattice, and their ratio in size.

The mapping function may be a composition of a rotation function and a distortion function, wherein the rotation function rotates every point of the image plane about an axis perpendicular to the plane (rotation axis) by an angle the magnitude of which is the same for all points of the image plane, the axis passing through a centre point, and wherein the distortion function translates every point of the image plane in a radial direction relative to the centre point into a radially translated point, the distance between the centre point and the translated point being a function of the distance between the centre point and the non-translated original point. The centre point, i.e. the point where the rotation axis cuts the image plane, may lie in the centre of the image field. The rotation axis may in particular coincide with an optical axis of the imaging system. However, this is not necessarily the case. The rotation axis may pass through an arbitrary point in the image plane, even through a point outside the part of the image plane that is actually captured by the sensor. Thus the word “centre” refers here to the centre of distortion, not to the midpoint of, e.g., the image field or the sensitive area of the image sensor. The rotation function is needed if the auxiliary lattice and the Bravais lattice of the probe light spots are rotated relative to each other by a certain angle. For example, the auxiliary lattice might be defined such that one of its lattice vectors is parallel to one of the edges of the sensitive area of the image sensor, whereas the corresponding lattice vector of the lattice of the image light spots and the edge of the sensitive area define a non-zero angle. Regarding the distortion function, the distance between the centre point and the translated point may in particular be a nonlinear function of the distance between the centre point and the non-translated original point.

The distortion function may have the form

r′=γƒ(β,r)r,

r being the vector from the centre point to an arbitrary point of the image plane, r′ being the vector from the centre point to the radially translated point, β being a distortion parameter, γ being a scale factor, r being the length of the vector r, and the factor ƒ(β, r) being a function of β and r.

The factor ƒ(β, r) may be given by

ƒ(β,r)=1+βr².

The distortion function is thus given

r′=γ(1+βr²)r,

a form that is well-known in the art.

The step of fitting the mapping function may comprise fitting first the rotation function and fitting then the distortion function. The rotation function may, for example be fitted to recorded imaga data relating only to a centre region of the sensitive area where the distortion effect may be negligible. Once the rotation function has been determined, at least approximately, the distortion function may be fitted more easily. Of course, the mapping function may be further adjusted in conjunction with the distortion function.

The step of fitting the mapping function may comprise fitting first a value of the scale factor γ and fitting then a value of the distortion parameter β. The scale factor γ may, for example, be determined, at least approximately, from image data relating to a centre region of the sensitive area where distortion effects may be negligible.

In the step of fitting the mapping function, the mapping function may be determined iteratively. The mapping function may, for example, be determined by a genetic algorithm or by a method of steepest descent.

The mapping function may be memorized on an information carrier. In this context “memorizing the mapping function” means memorizing all parameters necessary to represent the mapping function, such as a rotational angle and a distortion parameter. The mapping function may in particular be memorized in a random-access memory of an information processing device coupled to the image sensor.

According to a second aspect of the invention, the measuring system for determining the distortion of an imaging system comprises
a spot generator for generating an array of probe light spots in the object plane, the probe light spots being arranged according to a one-dimensional or two-dimensional Bravais lattice,
an image sensor having a sensitive area arranged so as to be able to interact with the array of image light spots,
an information processing device coupled to the image sensor, wherein the information processing device carries executable instructions for carrying out the following steps of the method as claimed claim 1:
reading image data from the image sensor;
determining the positions of the image light spots; and
fitting a mapping function.
   The image sensor may in particular be a pixelated image sensor such as a pixelated photodetector. The information processing device may comprise an integrated circuit, a PC, or any other type of data processing means, in particular any programmable information processing device.

According to a third aspect of the invention, the method of imaging a sample comprises the steps of
placing a sample in the object plane;
generating an array of probe light spots in the object plane and thus in the sample, thereby generating a corresponding array of image light spots in the image plane, wherein the probe light spots are arranged according to a one-dimensional or two-dimensional Bravais lattice;
placing an image sensor such that a sensitive area thereof interacts with the image light spots;
determining readout points on the sensitive area of the image sensor by applying a mapping function to the lattice points of an auxiliary lattice, the auxiliary lattice being geometrically similar to the Bravais lattice of the probe light spots; and
reading image data from the readout points on the sensitive area.
   The image sensor may in particular be a pixelated image sensor. In this case the step of reading image data may comprise
reading image data from readout sets, each readout set being associated with a corresponding readout point and comprising one or more pixels of the image sensor, the one or more pixels being situated at or near the corresponding readout point.

The array of probe light spots and the array of image light spots may be immobile relative to the image sensor. The method may then comprise a step of scanning the sample through the array of probe light spots. Thereby the array of probe light spots is displaced relative to the sample whereby different positions on the sample are probed.

The method may further comprise a step of fitting the mapping function by the method according to the first aspect of the invention.

According to a fourth aspect of the invention, the information processing device coupled to the image sensor of a multispot optical scanning device carries executable instructions for performing the following steps of the method discussed above with reference to the third aspect of the invention:
determining readout points on the image sensor; and
reading image data from the readout points.
   Thus the readout points on the image sensor can be determined in an automated fashion, and the image data can be read from the readout points in an automated fashion. The mapping function may have been determined by the method as described above with reference to the first aspect of the invention. The mapping function may, for example, be characterized by the distortion parameter β introduced above.

The sensitive area of the image sensor may be flat. It should be noted that image distortion may also be largely compensated by using an image sensor having an appropriately curved sensitive area. However, a flat image sensor is considerably simpler to manufacture than a curved one, and the problems of distortion that usually arise when using a flat image sensor can be overcome by determining the readout points in an appropriate manner, as explained above.

The multispot optical scanning device may comprise a measuring system as described in relation with the second aspect of the invention. This allows for fitting the mapping function by means of the multispot optical scanning device itself.

In this case the spot generator, the image sensor, and the information processing device may, respectively, be the spot generator, the image sensor, and the information processing device of the measuring system. Thus each of these elements may be employed for two purposes, namely determining the distortion of the imaging system and probing a sample.

In summary, the invention gives a method for correcting artefacts caused by common distortions of the optical imaging system of a multispot scanning optical device, in particular of a multispot scanning optical microscope. The known regularity of the spot array in the optical device may be exploited to first measure, and then correct for, the barrel or pincushion-type lens distortion that is present in the optical imaging system. Thereby artefacts caused by said distortion in the images generated by the multispot microscope are strongly reduced, if not completely eliminated. The method generally allows improving the images acquired by the multispot device. At the same time it allows for the use of cheaper lenses with stronger barrel distortion while maintaining the same image quality. Additionally, the invention summarized here can be used for measuring the lens distortion of a large variety of optical systems.

### BRIEF DESCRIPTION OF THE DRAWINGS

FIG. 1 schematically illustrates an example of a multispot optical scanning device.

FIG. 2 schematically illustrates an array of light spots generated within a sample.

FIG. 3 illustrates a recorded array of image light spots and an auxiliary lattice.

FIG. 4 illustrates the recorded array of image light spots shown in FIG. 3 and a mapped auxiliary lattice

FIG. 5 illustrates a rotation function.

FIG. 6 illustrates a distortion function.

FIG. 7 is a flow chart of a method according to the first aspect of the invention.

FIG. 8 is a flow chart of a method according to the third aspect of the invention.

### DETAILED DESCRIPTION OF THE INVENTION

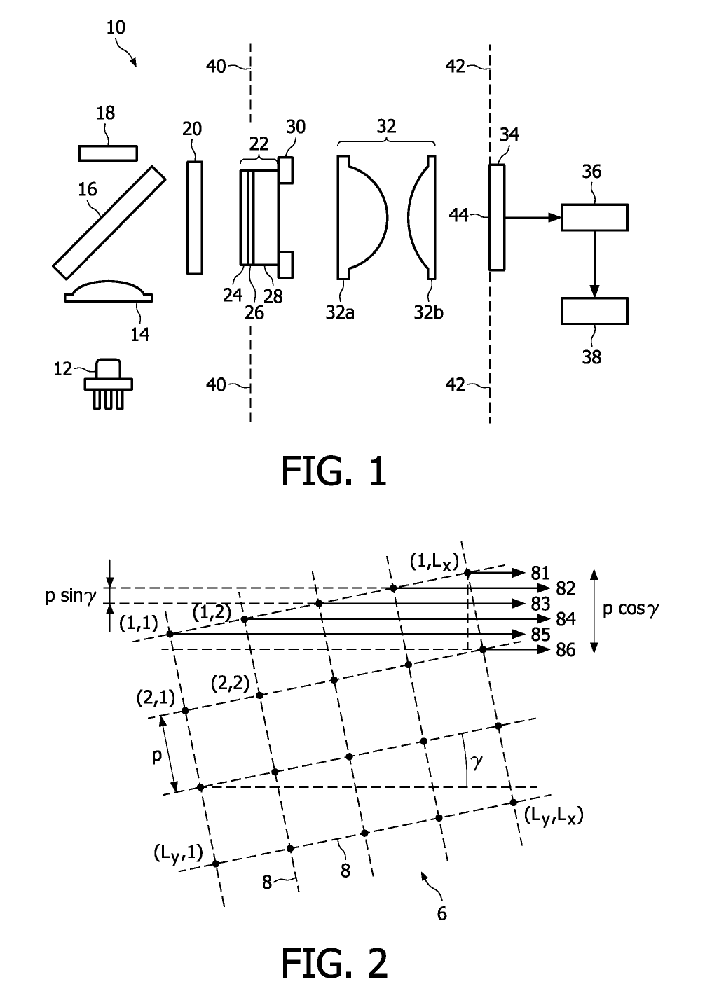

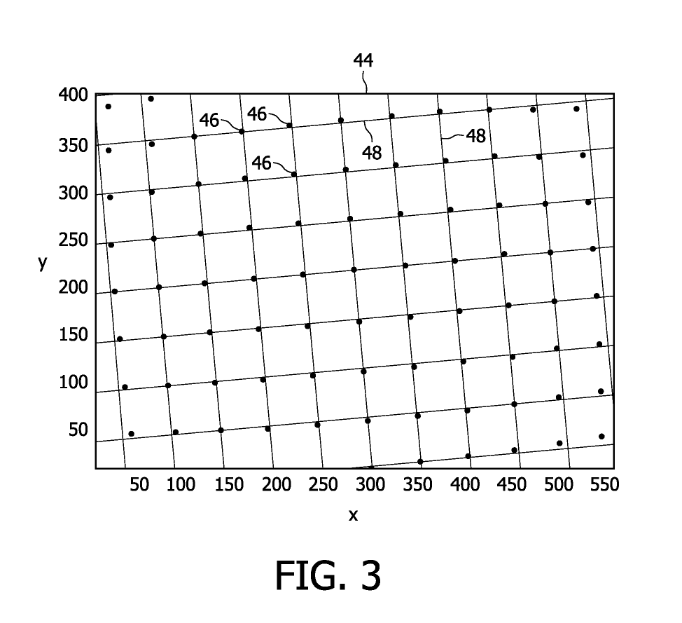

Represented in FIG. 3 is the sensitive area 44 of the image sensor 34 described above with reference to FIG. 1. Also indicated are the image light spots 46 focused on the sensitive area 44 by means of the imaging optics 32. An auxiliary Bravais lattice 46 that is geometrically similar to the Bravais lattice 8 of the probe light spots 6 shown in FIG. 1 is also indicated. The size and orientation of the auxiliary lattice 48 have been chosen such that its lattice points, i.e. the intersections of the lines used to illustrate the lattice 48, coincide with the image light spots 48 in a region surrounding the centre point of the sensitive area 44, the centre point being the point where the optical axis (not shown) of the imaging system 34 cuts the sensitive area 44. It is emphasized that while the image light spots 46 are physical, the auxiliary lattice 48 is an abstract concept. A simple way of determining readout points on the sensitive area 44 at which recorded light intensity values are to be read out would be to choose as readout points the lattice points of the auxiliary lattice 48. However, due to barrel-type distortion of the imaging system 32 the agreement between the points of the auxiliary lattice 48 and the positions of the image light spots 46 is rather poor near the corners of the sensitive area 44. While the agreement is perfect at the centre of the sensitive area, it deteriorates in relation to the distance between the point in question and the image centre. Thus, if the recorded intensity were read out the lattice points of the auxiliary Bravais lattice 48, substantial artefacts in the digital image of the sample would arise due to the fact that the intensity recorded at the readout points would generally be significantly lower than the intensity at the positions of the image light spots 46.

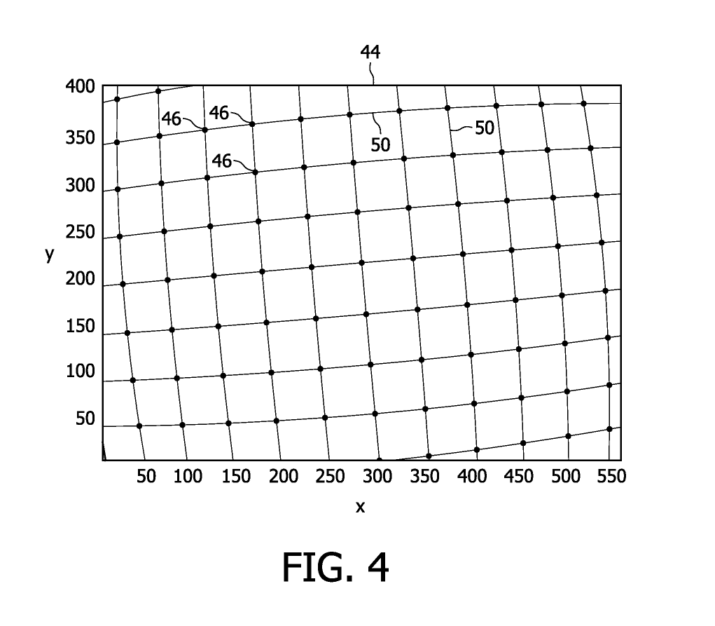

Shown in FIG. 4 are the sensitive area 44 and the image light spots 46 discussed above with reference to FIG. 3. Also indicated is a distorted lattice 50. The distorted lattice 50 is obtained from the auxiliary Bravais lattice 48 discussed above with reference to FIG. 3 by applying to each lattice point of the Bravais lattice 48 a mapping function that maps an arbitrary point of the Figure plane (i.e. the image plane 42 shown in FIG. 1) into another point of the Figure plane. The mapping function is, in its most general form, a composition of a translation, a rotation, and a distortion. However, due the periodicity of the lattice, the translation function may be ignored. In the example shown, the mapping function has been determined by first analyzing the entire sensitive area 44 of the image sensor to find the positions of the image light spots 46 and then fitting a distortion parameter 13 such that each lattice point of the distorted lattice 50 coincides with the position of a corresponding image light spot 46. The lattice points of the distorted Bravais lattice 50 are then chosen as readout points. By extracting intensity data only from those pixels of the sensitive area 44 which cover a readout point, correct (artefact-free) information is obtained about the sample 26 shown in FIG. 1 at the positions of the probe light spots 6 shown in FIG. 1. Operating the multispot microscope in a mode where the intensity of the spots is acquired not at the lattice points of the Bravais lattice 48 but at the lattice points of the distorted Bravais lattice 50 produces significantly smaller artefacts in the resulting intensity and contrast images. As an added benefit, this distortion-compensated method of finding the readout points also returns the distortion properties (distortion axis and strength) of the optical system.

The proposed method for eliminating the distortion in a multispot image thus comprises two steps. The first step is the measurement of the parameters of the actual barrel or pincushion type of lens distortion of the optical imaging system, by exploiting the known regular structure of the spot array. The second step is the adjustment of the positions on the image sensor from which the intensity data for the individual spots is acquired. According to the invention, both steps are advantageously performed in the digital domain, using the digital image acquired from the image sensor.

A straightforward way of measuring the lens distortion, by exploiting the regular structure of the spot array, is by means of iteration. By iteratively distorting an auxiliary Bravais lattice until it fits the recorded arrangement of spots in the sensor image the distortion parameters of the (system of) lens(es) are obtained.

For example, in the case of a square lattice the position of spot (j,k), with j and k integer, is given by

\vec{r}ⱼₖ=\vec{r}₀+Δ\vec{r}ⱼₖ

Δ\vec{r}ⱼₖ=(j,k)p

where \vec{r}₀ is the centre of the image, and where the x and y-axes are taken along the array directions. The distorted lattice then gives the position of spot (j,k) as:

\vec{r}ⱼₖ=\vec{r}₀+(1+β|Δ\vec{r}ⱼₖ|²)Δ\vec{r}ⱼₖ

Δ\vec{r}ⱼₖ=(j,k)p

where β is a parameter describing the lens distortion (β>0 for barrel distortion and β<0 for pincushion distortion). Apart from the pitch p and possibly a rotational angle, which can both be determined independently, at least approximately, in a preceding step, there is only one parameter that needs to be fitted, namely the distortion parameter β.

The distortion of virtually any optical imaging system can thus be measured by illuminating the field of the optical imaging system by an array of spots and fitting a distorted array through the recorded image. This can be done continuously in order to monitor a possible change in distortion over time.

The error usually affecting the quality of digital images due to the distortion shown in FIG. 3. is corrected while the intensity data of the individual spots is extracted from the image sensor data. Instead of extracting the intensity data from the pixels where the image spots 46 would be in the case of an undistorted projection of the probe spots 6 (shown in FIG. 1) the intensity data is sampled at the actual positions of the image spots 46, taking into account the distortion of the (system of) lens(es).

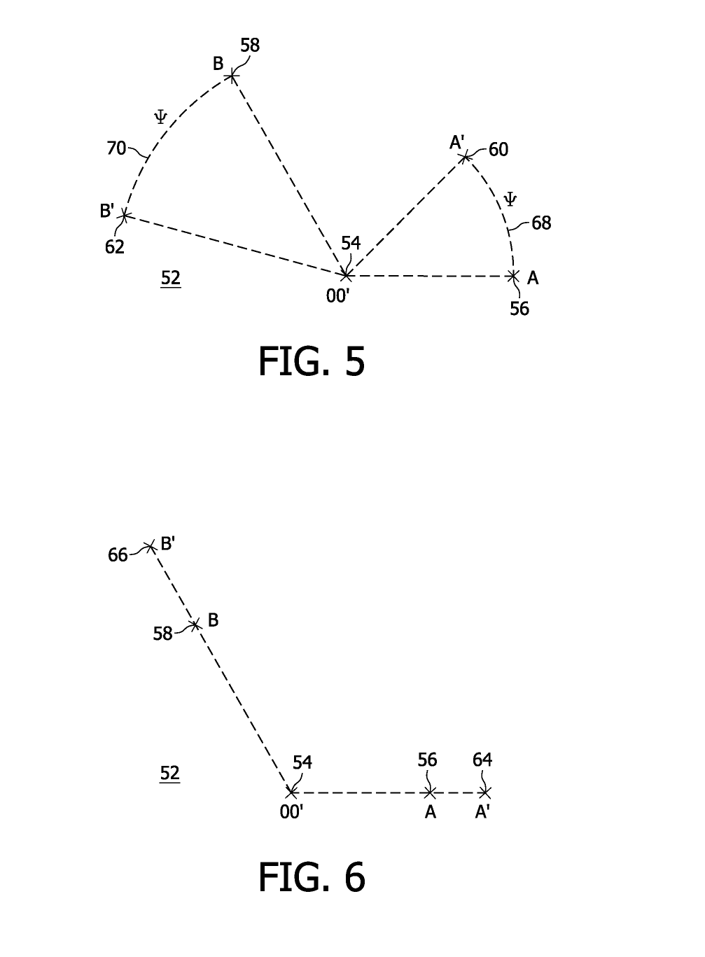

FIGS. 5 and 6 schematically illustrate a rotation (rotation function) and a distortion (distortion function), respectively.

Referring to FIG. 5, the rotation function rotates every point of the image plane 42 about an axis perpendicular to the plane 42 by an angle 68 the magnitude of which is the same for all points of the plane 42. The axis passes through a centre point 54. Thus point 56 is rotated into point 60. Similarly, point 58 is rotated into point 62. The angle 68 between the original point 56 and the rotated point 60, and the angle 70 between the original point 58 and the rotated point 62 are equal in magnitude.

Referring to FIG. 6, the distortion function translates every point of the plane in a radial direction relative to the centre point 54 into a radially translated point, the distance between the centre point 54 and the translated point 64 being a function of the distance between the centre point 54 and the non-translated original point. Accordingly, the original point 56 is radially translated into a radially translated point 64, while the original point 58 is radially translated into a radially translated point 66.

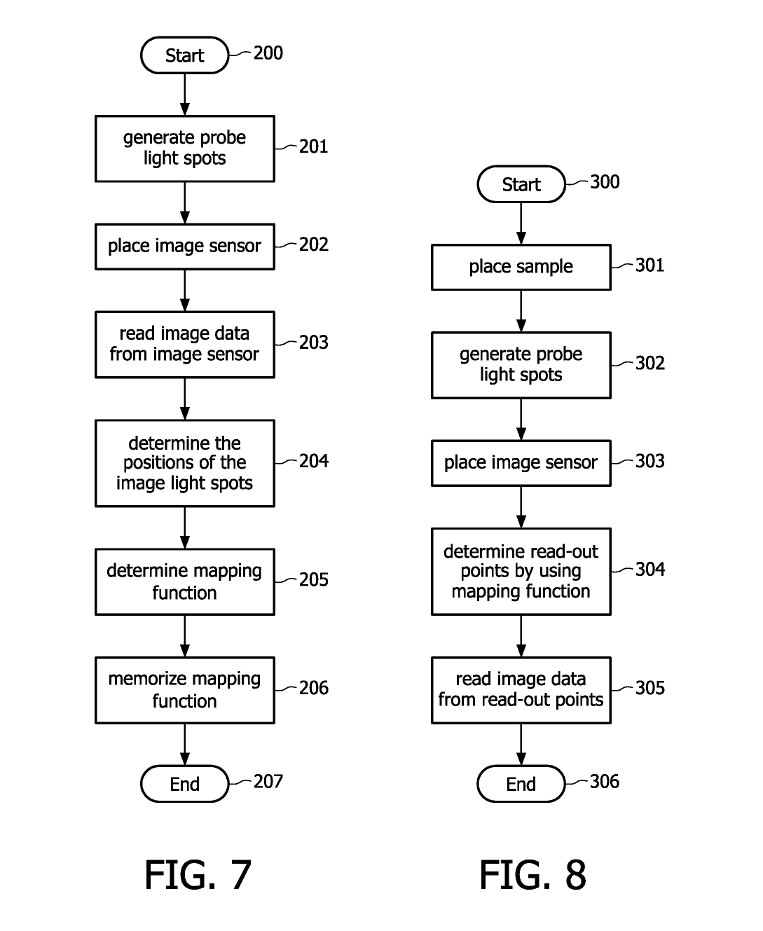

Referring now to FIG. 7, there is illustrated an example of a method of measuring the distortion of the imaging system 32 shown in FIG. 1 (all reference signs not appearing in FIG. 7 refer to FIGS. 1 to 6). The method starts in step 200. In a subsequent step 201 an array of probe light spots 6 in the object plane 40 is generated. Thereby a corresponding array of image light spots 46 is generated in the image plane 42. The probe light spots 6 are arranged according to a one-dimensional or two-dimensional Bravais lattice 8. In step 202, which is performed simultaneously with step 201, an image sensor 34 is placed such that its sensitive area 44 interacts with the image light spots 46. In step 203, performed simultaneously with step 202, image data is extracted from the image sensor 34. In subsequent step 204 the positions of the image light spots 46 on the image sensor 34 are determined by analyzing the image data. In a subsequent step 205 a mapping function is fitted such that the mapping function maps the lattice points of an auxiliary lattice 48 into the determined positions of the image light spots 46, wherein the auxiliary lattice 48 is geometrically similar to the Bravais lattice 8 of the probe light spots 6. In a subsequent step 206, at least one parameter characterizing the mapping function, in particular at least one distortion parameter, is stored in a random-access memory (RAM) of the PC to make the mapping function available for, e.g., defining readout points on the sensitive area 44 of the image sensor 34.

The method described above with reference to FIG. 7 may comprise a feedback loop for adjusting the imaging system 32. In this case, step 205 is followed by a step (not shown) of adjusting the imaging system 32, in which the imaging system 32 is adjusted, for example by shifting lenses, or, in case of e.g. a fluid focus lens, changing a lens curvature, so as to reduce the distortion of the imaging system 32. The adjustment may be an iterative “trial and error” process. By adjusting the imaging system 32 as a function of the mapping function determined in the previous step 205, the adjustment process may be sped up. After adjusting the imaging system 32, the process returns to step 203. This process could be used to keep the distortion stable, e.g. for compensation of temperature changes, or other changes in the imaging system.

Referring now to FIG. 8, there is represented an example of a method of imaging a sample (all reference signs not appearing in FIG. 8 refer to FIGS. 1 to 6). The method makes use of an imaging system 32 having an object plane 40 and an image plane 42 as described above in an exemplary manner with reference to FIG. 1. The method starts in step 300. In a subsequent step 301, a sample, for example a transparent slide containing biological cells, is placed in the object plane 40. Simultaneously an array of probe light spots 6 is generated in the object plane 40 and thus in the sample, wherein the probe light spots 46 are arranged according to a one-dimensional or two-dimensional Bravais lattice 8. Thereby a corresponding array of image light spots 46 is generated in the image plane 42 (step 302). Simultaneously an image sensor 34 is placed such that its sensitive area 44 interacts with the image light spots 46 (step 303). In step 304, which may also be performed as a preparative step before, for example, step 301, readout points on the sensitive area 44 of the image sensor 34 are determined by applying a mapping function to the lattice points of an auxiliary lattice 48, the auxiliary lattice being geometrically similar to the Bravais lattice 8 of the probe light spots 6. The mapping function may be defined in terms of parameters, in particular at least one distortion parameter, which may have been read from a memory of the PC 38 in a step preceding step 304. In a subsequent step 305, image data is read from the readout points on the sensitive area 44. The image data is further processed by the PC 38 to produce a visible image.

In a variant of the method described above with reference to FIG. 8, the distortion of the imaging system 32 is measured and compensated for many times during a scanning operation, for example, once per readout frame of the image sensor 34. This may be represented by a loop (not shown) over steps 304 and 305, wherein the loop further comprises a step (not shown) of determining the mapping function, the step of determining the mapping function being performed before step 304.

While the invention has been illustrated and described in detail in the drawings and in the foregoing description, the drawings and the description are to be considered exemplary and not restrictive. The invention is not limited to the disclosed embodiments. Equivalents, combinations, and modifications not described above may also be realized without departing from the scope of the invention.

The verb “to comprise” and its derivatives do not exclude the presence of other steps or elements in the matter the “comprise” refers to. The indefinite article “a” or “an” does not exclude a plurality of the subjects the article refers to. It is also noted that a single unit may provide the functions of several means mentioned in the claims. The mere fact that certain features are recited in mutually different dependent claims does not indicate that a combination of these features cannot be used to advantage. Any reference signs in the claims should not be construed as limiting the scope.

1. A method of determining the distortion of an imaging system (32), the imaging system having an object plane (40) and an image plane (42), wherein the method comprises the steps of
generating (201) an array of probe light spots (6) in the object plane (40), thereby generating a corresponding array of image light spots (46) in the image plane (42), wherein the probe light spots (6) are arranged according to a one-dimensional or two-dimensional Bravais lattice (8);
placing (202) an image sensor (34) such that a sensitive area (44) thereof interacts with the image light spots (46);
reading (203) image data from the image sensor (34);
determining (204) the positions of the image light spots (46) on the sensitive area (44) by analyzing the image data; and
fitting (205) a mapping function such that the mapping function maps the lattice points of an auxiliary lattice (48) into the positions of the image light spots (46), wherein the auxiliary lattice (48) is geometrically similar to the Bravais lattice (8) of the probe light spots (6).

2. The method as claimed in claim 1, wherein the mapping function is a composition of a rotation function and a distortion function, wherein the rotation function rotates every point (56) of the image plane (42) about an axis perpendicular to the image plane by an angle (68) the magnitude of which is the same for all points of the image plane (42), the axis passing through a centre point (54), and wherein the distortion function translates every point (56) of the image plane in a radial direction relative to the centre point (54) into a radially translated point (64), the distance between the centre point (54) and the translated point (64) being a function of the distance between the centre point (54) and the non-translated original point (56).

3. The method as claimed in claim 2, wherein the distortion function has the form
r′=γƒ(β,r)r,
r being the vector from the centre point (54) to an arbitrary point (56) of the image plane (42), r′ being the vector from the centre point (54) to the radially translated point (64), β being a distortion parameter, γ being a scale parameter, r being the length of r, and the factor ƒ(β, r) being a function of β and r.

4. The method as claimed in claim 3, wherein the factor ƒ(β, r) is given by
ƒ(β,r)=1+βr².

5. The method as claimed in claim 2, wherein the step of fitting (205) the mapping function comprises
fitting first the rotation function; and
fitting then the distortion function.

6. The method as claimed in claim 3, wherein the step of fitting (205) the mapping function comprises
fitting first a value of the scale factor γ; and
fitting then a value of the distortion parameter β.

7. The method as claimed in claim 1, wherein the step of fitting (205) the mapping function comprises
determining the mapping function iteratively.

8. The method as claimed in claim 1, further comprising the step of:
memorizing (206) the mapping function on an information carrier (36, 38).

9. A measuring system (10) for determining the distortion of an imaging system (32) having an object plane (40) and an image plane (42), the measuring system comprising
a spot generator (10) for generating an array of probe light spots (6) in the object plane (40), thereby generating a corresponding array of image light spots (46) in the image plane (42), the probe light spots being arranged according to a one-dimensional or two-dimensional Bravais lattice (8),
an image sensor (34) having a sensitive area (44) arranged so as to be able to interact with the array of image light spots (46), and
an information processing device (36, 38) coupled to the image sensor (34), wherein the information processing device carries executable instructions for carrying out the following steps of the method as claimed claim 1:
reading (203) image data from the image sensor (34);
determining (204) the positions of the image light spots (46); and
fitting (205) a mapping function.

10. A method of imaging a sample (26), using an imaging system (32) having an object plane (40) and an image plane (42), the method comprising the steps of
placing (301) the sample (26) in the object plane (40);
generating (302) an array of probe light spots (6) in the object plane (40) and thus in the sample, thereby generating a corresponding array of image light spots (46) in the image plane (42), wherein the probe light spots are arranged according to a one-dimensional or two-dimensional Bravais lattice (8);
placing (303) an image sensor (34) such that a sensitive area (44) thereof interacts with the image light spots (46);
determining (304) readout points on the sensitive area (44) of the image sensor (34) by applying a mapping function to the lattice points of an auxiliary lattice (48), the auxiliary lattice being geometrically similar to the Bravais lattice (8) of the probe light spots (6); and
reading (305) image data from the readout points on the sensitive area (44).

11. The method as claimed in claim 10, wherein the array of probe light spots (6) and the array of image light spots (46) are immobile relative to the image sensor (34), and wherein the method comprises a step of
scanning the sample (26) through the array of probe light spots (6).

12. The method as claimed in claim 10, further comprising a step of
fitting (205) the mapping function by the method of determining the distortion of an imaging system (32), the imaging system having an object plane (40) and an image plane (42), wherein the method comprises the steps of
generating (201) an array of probe light spots (6) in the object plane (40), thereby generating a corresponding array of image light spots (46) in the image plane (42), wherein the probe light spots (6) are arranged according to a one-dimensional or two-dimensional Bravais lattice (8);
placing (202) an image sensor (34) such that a sensitive area (44) thereof interacts with the image light spots (46);
reading (203) image data from the image sensor (34);
determining (204) the positions of the image light spots (46) on the sensitive area (44) by analyzing the image data; and
fitting (205) a mapping function such that the mapping function maps the lattice points of an auxiliary lattice (48) into the positions of the image light spots (46), wherein the auxiliary lattice (48) is geometrically similar to the Bravais lattice (8) of the probe light spots (6).

13. A multispot optical scanning device (10), in particular a multispot optical scanning microscope, comprising
an imaging system (32) having an object plane (40) and an image plane (42),
a spot generator (20) for generating an array of probe light spots (6) in the object plane (40), thereby generating a corresponding array of image light spots (46) in the image plane (42), wherein the probe light spots (6) are arranged according to a one-dimensional or two-dimensional Bravais lattice (8),
an image sensor (34) having a sensitive area (44) arranged so as to be able to interact with the array of image light spots (46), and
an information processing device (36, 38) coupled to the image sensor (34),
wherein the information processing device carries executable instructions for performing the following steps of the method as claimed in claim 10:
determining (304) readout points on the image sensor (34); and
reading (305) image data from the readout points.

14. The multispot optical scanning device (10) as claimed in claim 13, wherein the sensitive area (44) of the image sensor (34) is flat.

15. The multispot optical scanning device (10) as claimed in claim 13, wherein the multispot optical scanning device comprises a measuring system (10) for determining the distortion of an imaging system (32) having an object plane (40) and an image plane (42), the measuring system comprising
a spot generator (10) for generating an array of probe light spots (6) in the object plane (40), thereby generating a corresponding array of image light spots (46) in the image plane (42), the probe light spots being arranged according to a one-dimensional or two-dimensional Bravais lattice (8),
an image sensor (34) having a sensitive area (44) arranged so as to be able to interact with the array of image light spots (46), and
an information processing device (36, 38) coupled to the image sensor (34),
wherein the information processing device carries executable instructions for carrying out the following steps of the method:
reading (203) image data from the image sensor (34);
determining (204) the positions of the image light spots (46); and
fitting (205) a mapping function.

16. The multispot optical scanning device (10) as claimed in claim 15, wherein the spot generator (20), the image sensor (34), and the information processing device (36, 38) are, respectively, the spot generator (20), the image sensor (34), and the information processing device (36, 38) of the measuring system.
